(19) United States
(12) Patent Application Publication
(10) Pub. No.: US 2013/0075678 A1
(43) Pub. Date: Mar. 28, 2013

(54) LOW PROFILE JACK

(71) Applicant: Quantum Engineered Products, Inc., Saxonburg, PA (US)

(72) Inventors: Joseph W. Kozora, Saxonburg, PA (US); Michael J. Albert, Cabot, PA (US); Travis R. McDougal, Butler, PA (US)

(73) Assignee: QUANTUM ENGINEERED PRODUCTS, INC., Saxonburg, PA (US)

(21) Appl. No.: 13/625,326

(22) Filed: Sep. 24, 2012

Related U.S. Application Data
(60) Provisional application No. 61/538,456, filed on Sep. 23, 2011.

(51) Int. Cl. B66F 3/08

(52) U.S. Cl. 254/126

(57) ABSTRACT

A jack assembly includes a dual threaded screw with a right-hand-threaded section and a left-hand-threaded section. A first drive member mates with the right-hand-threaded section, and a second drive member mates with the left-hand-threaded section. The drive members drive an extendible platform that moves to an extended position when the screw is moved in a first direction, or a retracted position when the screw is moved in a second, opposite direction.

### RELATED APPLICATIONS AND CLAIM OF PRIORITY

This patent document claims priority to U.S. Provisional Patent Application No. 61/538,456, filed Sep. 23, 2011, titled “Low Profile Jack”, the disclosure of which is incorporated herein by reference in its entirety.

### BACKGROUND

This document generally relates to lifting and stabilizing mechanisms that are used for raising heavy objects. More particularly the document relates to a jack having a low profile when it is in a retracted position.

Many lifting and stabilizing mechanisms are known for raising heavy objects, such as automobiles, recreational vehicle trailers, heavy mechanical machinery and other objects. When a lifting and stabilizing mechanism is not in use, or when it is first placed under an object to be raised, the mechanisms typically are in a retracted position. Although the retracted position is less high than the mechanism's extended position, the retracted position still requires ample space. The size of a retracted mechanism creates storage issues, and it limits the applications for which the mechanism may be used.

This document describes a device that addresses at least some of these problems.

### SUMMARY

In an embodiment, a jack assembly includes a dual threaded screw with a right-hand-threaded section and a left-hand-threaded section. A first drive member has an internal thread that mates with the right-hand-threaded section, and a second drive member has an internal thread that mates with the left-hand-threaded section. The drive members drive an extendible platform that is pivotably related to each drive member. When the screw is rotated in a first direction, the drive members move toward each other so that the platform moves to an extended position. When the screw is moved in a second, opposite direction, the drive members move away from each other to a retracted position.

In some embodiments, the extendible platform includes a first side wall and a first hinge that connects the first side wall to the first drive member. The extendible platform also may include a second side wall and a second hinge that connects the second side wall to the second drive member. In some embodiments, the extendible platform also may include a support surface positioned between the first side wall and the second side wall, a third hinge that connects the support surface to the first side wall, and a fourth hinge that connects the support surface to the second side wall. Alternatively or in addition, the extendible platform may include a receiving structure that is positioned between the first side wall and the second side wall when the platform is in the extended position.

In some embodiments, the screw may include a non-threaded section positioned between the right-hand thread and the left-hand thread, such that the non-threaded section has a length that exceeds a corresponding width of the support surface. The right-hand thread and/or the left-hand thread may have an Acme thread form.

The assembly also may include at least one lateral support member that is positioned to be parallel to the screw and to support the drive members. The assembly also may include a frame to which the screw and the lateral support member or members are attached. Optionally, when the extendible platform is in the retracted position, the support surface may not extend above a height of the frame. When the extendible platform is in the extended position, the support surface will be elevated above the frame. In some embodiments, the side walls may not be perpendicular to the support surface when the extendible platform is in a fully extended position. The assembly also may include any or all of the following: a handle in operative connection with the screw; a motor in operative connection with the screw; and a set of legs that extend angularly downward and away from the frame.

### BRIEF DESCRIPTION OF THE DRAWINGS

FIG. 1 is a perspective view of a first embodiment of a jack assembly in a partially extended position.

FIG. 2 is a top view of the first embodiment of a jack assembly in a retracted position.

FIG. 3 is a side view of the first embodiment of a jack assembly in a retracted position.

FIG. 4 is a side view of the first embodiment of a jack assembly in a fully extended position.

FIG. 5 is a block diagram of various elements of a jack assembly with an external drive.

FIG. 6 shows a second embodiment of a jack assembly in a fully extended position.

FIG. 7 shows the second embodiment of a jack assembly in a partially extended position.

FIG. 8 shows the second embodiment of a jack assembly in a retracted position.

FIG. 9 shows an underside view of the second embodiment of a jack assembly

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this document is to be construed as an admission that the embodiments described in this document are not entitled to antedate such disclosure by virtue of prior invention. As used in this document, the term “comprising” means “including, but not limited to.”

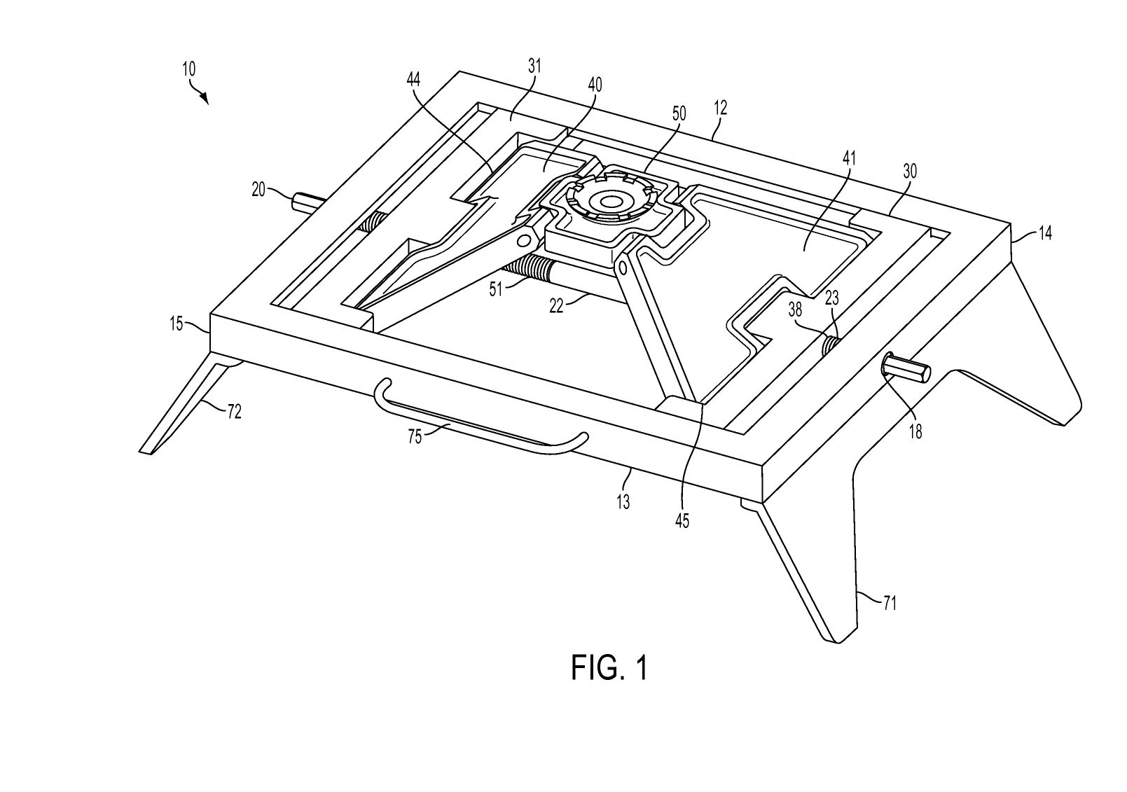

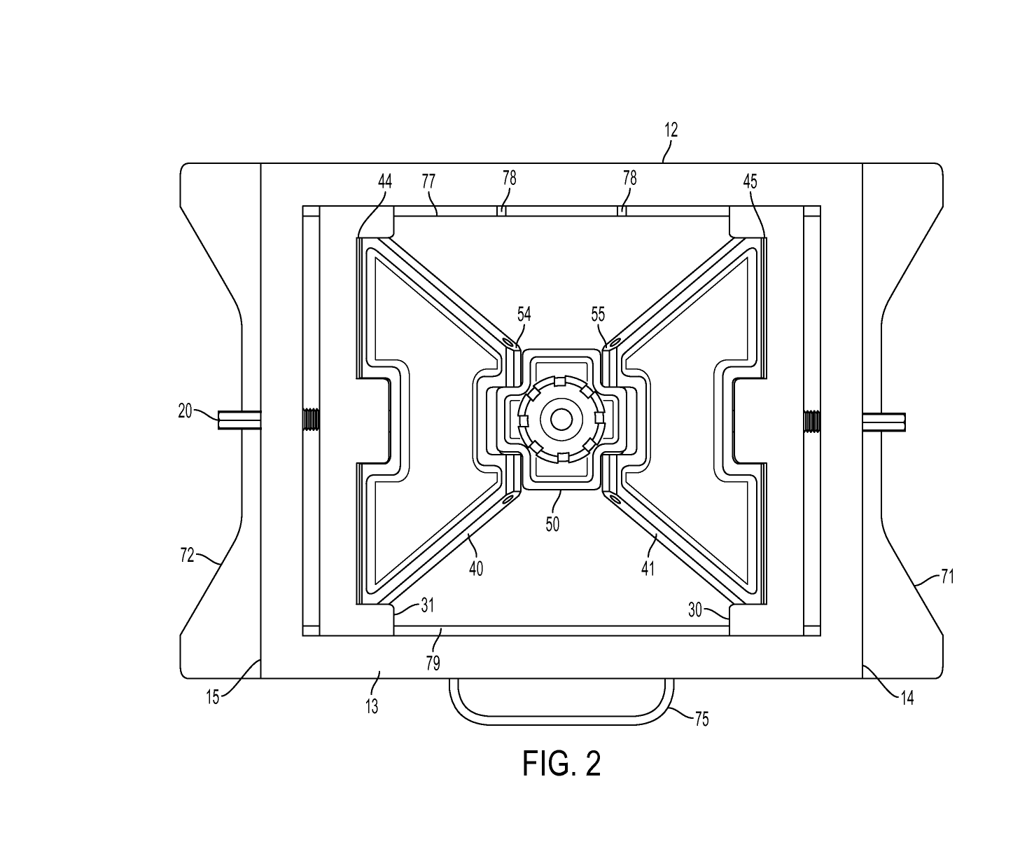

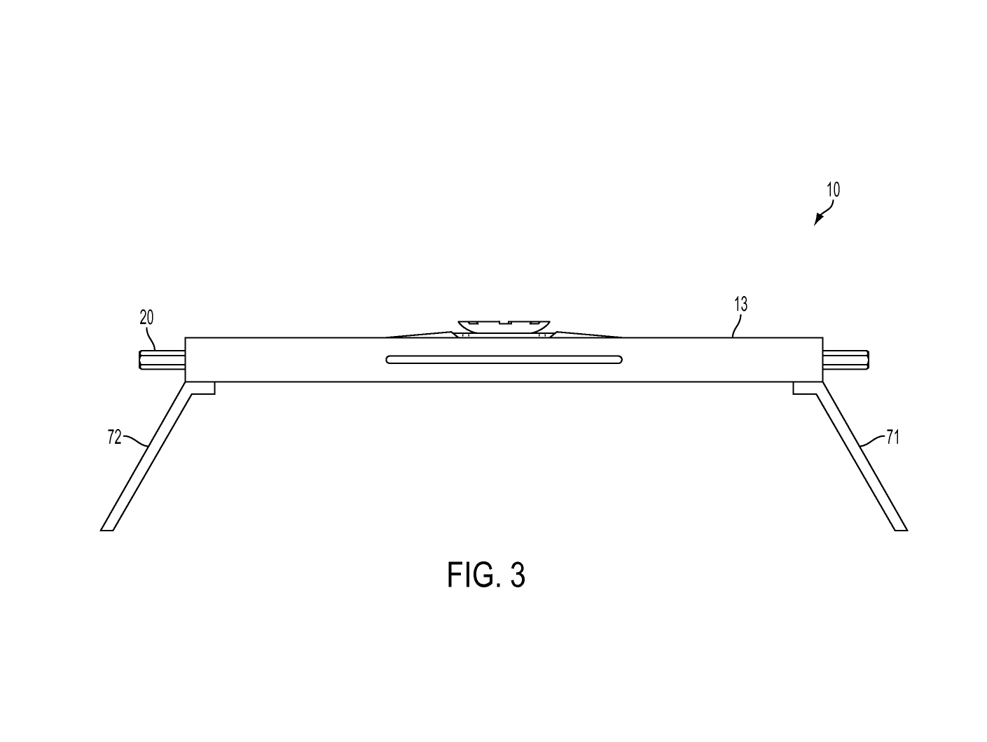

FIG. 1 illustrates an embodiment of a screw-operated jack-assembly 10 in a partially extended position. FIGS. 2 and 3 illustrate the assembly of FIG. 1 in a retracted position. Referring to FIGS. 1 and 2, the jack assembly includes a rigid frame that includes a pair of opposing side members 12, 13 and a pair of opposing end members 14, 15 that together provide a rectangular support structure. Other shapes and configurations of the frame are possible. A dual-threaded screw 20 extends from the first end member 14 to the second end member 15. The screw 20 includes a first section 21 having a right-handed thread, a second section 23 having a left-handed thread, and optionally an unthreaded central section 22 positioned between the first and second threaded sections. Each end of the screw may include an unthreaded portion that is directly or indirectly attached to an end member via a non-threaded receptacle 18 that prevents lateral movement of the screw while allowing the screw to rotate. As shown in FIG. 1, optionally the screw ends may have an exterior shape that is non-circular, such as in the shape of a polygon, to engage a receptacle having a corresponding shape.

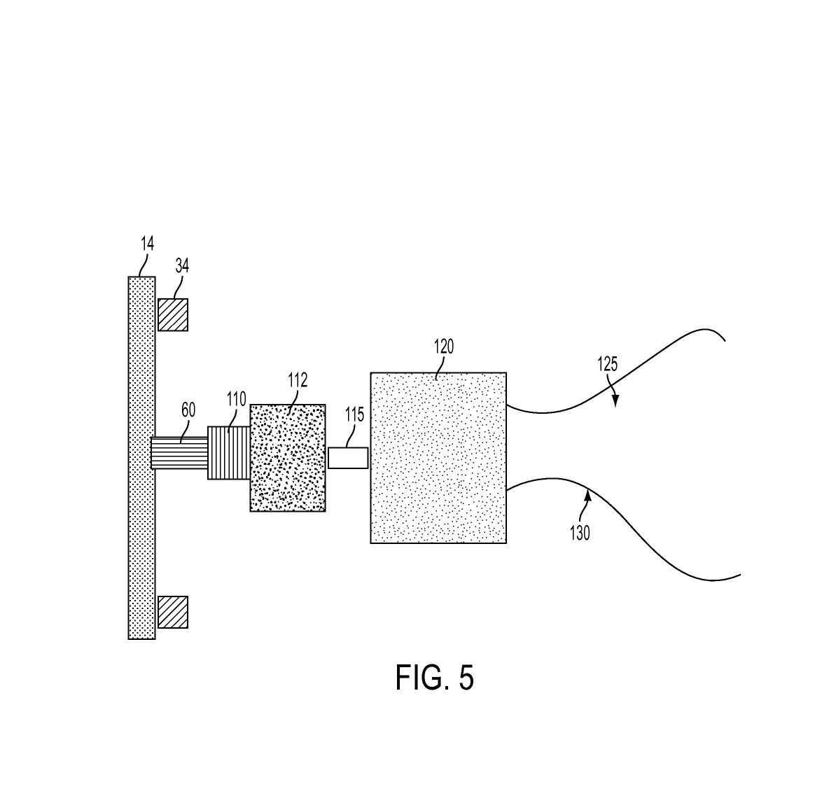

A screw drive (not shown) such as a wrench, handle, hook or other turning structure may be used to grasp and rotate the screw, may be attached to one end of the screw so that the screw may be rotated by an external force. Alternatively, the screw 20 may include an integral handle or other structure that assists in turning of the screw. Optionally, the screw 20 and/or its drive may be attached to an external motor or other power-driven mechanism that turns the screw when activated, as discussed below in the context of FIG. 5.

Two movable drive members 30, 31 are each attached to the screw 20 by an internal threaded receptacle 38. The internal thread of one of the drive members 30 mates with the screw's left-handed thread and the internal thread of the other drive member 31 mates with the screw's right-handed thread, or vice-versa. When the screw 20 is rotated in one direction (e.g., clockwise), the drive members will move along the screw toward each other. When the screw 20 is rotated in the opposite direction (e.g., counterclockwise), the drive members will move away from each other.

To restrain the drive members from circular movement, the sides of each drive member 30, 31 may include a groove or slot that receives a tongue or other extendable member that protrudes from the adjacent side walls 12, 13. Alternatively, or the drive members 30, 31 may include a tongue or other extendable member that extends into a groove or slot of the adjacent side walls 12, 13. As another alternative, each drive member 30, 31 may rest on ledges 77, 79 positioned to extend inward (toward the interior of the frame) from each of the side walls 12, 13. As yet another alternative, each drive member 30, 31 may include a shelf that extends outward and over an upper portion of its corresponding side wall 12, 13. Any combination of any of these features, or similar features, may be used. Any of the lateral support members described above, whether they extend from the drive members or the side walls, may be in a position that is substantially parallel to that of the screw

An extendable platform that includes a pair of side walls 40, 41 and an optional planar support surface 50 is positioned between the drive members 30, 31. Each side wall 40, 41 is directly or indirectly connected to one of the drive members by one or more hinges 44, 45, which is a connecting mechanism that allows the side wall to pivot and turn upward when the drive members move together and turn downward when the drive members move apart. Each hinge may include a pin and receptacle, axle, linear bearing or other structure that allows for extension of the hinge's side wall up and away from the frame. The support surface 50 is positioned between the side walls and is similarly attached to each side wall 40, 41 by one or more hinges 54, 55 so that the plate remains in a planar position (i.e., parallel to the frame) as it is raised when the side walls are extended. Alternatively, the side walls 40 and 41 may be directly and pivotably connected to each other by one or more hinges so that they form an apex when in an extended position.

Each of the side walls 40, 41 of the extendable platform may include an underside with a relief area to accept a portion of the screw when the platform is retracted. Each relief area may be in the form of an opening, channel or groove on the underside of the side wall.

Two or more leg members 71, 72 may extend from the frame to raise the frame from the ground. As shown in FIGS. 1 and 2, the legs may extend outward at an angle, such as approximately 45 degrees or between 5 and 85 degrees, to expand the size of the device's bas and thus provide additional stability. In some embodiments, leg members 71, 72 may be retractable (for example connected to the frame by one or more hinges), or removable (for example connected to the frame by one or more screws, bolts, clips or pins) so that the device has a low profile for storage. In some embodiments, a handle 75 may extend from any portion of the frame to provide ease of carrying the frame.

When the extendable platform is fully extended as shown in FIG. 1, in some embodiments it may be designed so that the side walls 40, 41 are perpendicular, and thus not angled with respect to the support surface 50. In some embodiments, as shown the support surface 50 may include a receiving structure 70 of a size and shape to correspond to an item that is designed to be received. For example, the receiving structure 70 may include one or more pins or post, a bowl, a box-shape, or any other structure that will receive and help to hold a desired object to be lifted. Alternatively, the device may include no support surface at all, and the receiving structure 70 may be attached directly to one of the side walls, or it may rest on an apex formed by the side walls when in an extended position.

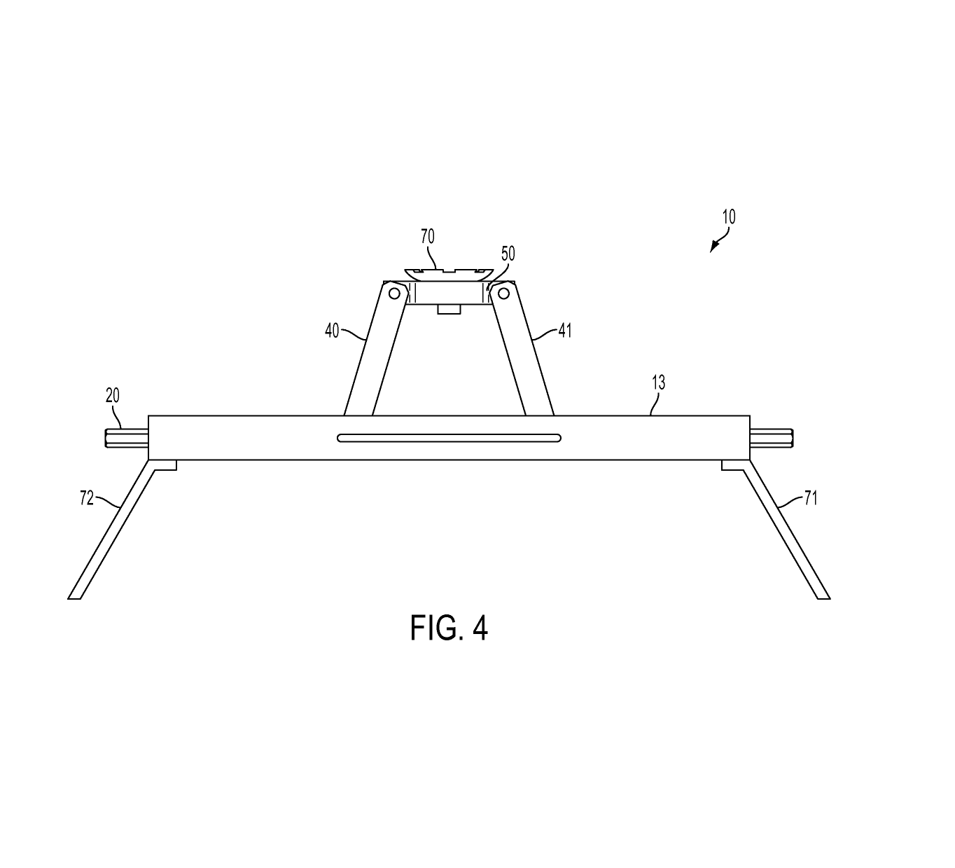

FIG. 4 shows the embodiment of the jack assembly 10 in a fully extended position. As shown in FIG. 4, in various embodiments the side walls may be angled and not be fully vertical (i.e., not perpendicular to the frame) when in an extendible position. Several designs are possible to ensure that the side walls are not allowed to become vertical. For example, referring to FIG. 1 and its view of a jack assembly from its underside, the screw 20 may have a non-threaded section 22 positioned between the right-hand thread 21 and the left-hand thread 23. The non-threaded section 22 may have a length that is larger than the width of the support surface 50 so that it limits lateral movement of the drive members toward each other and the side walls 40, 41 are never driven to be positioned completely underneath the support surface 50. Alternatively, a sleeve or other barrier may be placed over a central portion of the screw to serve as the non-threaded section 22. In addition or alternatively, one or both side walls 12, 13 may include a stop 78 that limits movement of the drive members. Alternatively, any other portion of the frame (including a bottom portion) may have a stop or slot that prevents further movement of the drive member when the bushing meets the stop.

Similarly, when the extendable platform is retracted as shown in FIG. 3, in some embodiments it may be designed so that the side walls 40, 41 are angled, and not parallel, with respect to the support surface 50. This helps to avoid placing a load on the screw when the device is retracted. Several designs are possible to ensure that this happens, such as designing the components of the extendible platform to be larger than a size that would allow the side walls to lie flat when the drive members reach their outer limit. When in a retracted position, in some embodiments the support surface 50 does not extend above the height of the frame so that the assembly may be easily stored.

Referring again to FIG. 1, the screw 20 is shown as a solid member having three sections: a non-threaded section 22 positioned between the right-hand thread 21 and the left-hand thread 23. The non-threaded section 22 is optional, and the right-hand thread 21 may abut the left-hand thread 23. In addition, the screw 20 may be made of multiple components that are interconnected by welding, mating, threading, or other connection devices. Each threaded area may have a trapezoidal thread form such as an Acme thread form, a square thread form, or a different type of thread form.

Optionally, the assembly may include a locking mechanism to secure the platform when it is in a raised position. Alternatively, the force of a load on the support surface 50 alone may be sufficient to disperse a force through the side walls 40, 41 to the drive members 30, 32 so that the internal threads of the drive members are forced against the screw threads to secure the platform in place by friction.

In some embodiments the support surface 50 may include one or more structures that are configured to secure a load in place. For example, the support surface 50 may include one or more integral or attached channels, receptacles, clamps, grooves, indentations, extensions, or other structures that are configured to position and/or receive the load.

As previously disclosed, the jack assembly can be operated using a drive member such as a handle or similar structure for manual activation. Alternatively, the screw drive can be activated through the use of a motor assembly. Various elements that may be included in such an assembly are illustrated in FIG. 5. End member 14 is shown on edge along with the end caps 34 that secure the support members (not shown) to the frame. In one embodiment, screw drive 60 is connected through a connector sleeve 110 to a gear box 112, the gear box 112 being connected in turn to a shaft 115 of a motor 120. Such a gear box may be used for high precision movement of the screw assembly 60, or to convert a low torque from motor 120 to a higher torque, required to move a heavy object. It is understood that gear box 112 is not necessarily required for operation of the jack assembly, and that screw drive 60 may be coupled through connector sleeve 110 directly to motor shaft 115. Motor 120 can comprise any of a number of types of electric motors, including DC motors or stepping motors. In an embodiment wherein motor 120 comprises a stepping motor, additional control components may be required. Such components may include a stepper motor controller. Such a controller may comprise electronic components including a microprocessor and a physical device for storing computerized instructions for activating motor 120. Such instructions may include the order of activating stepper motor windings, an acceleration/deceleration ramp profile, and other instructions commonly associated with stepper motor controls. Additionally, the motor controller may be in data communication with a computer or microcontroller that directs the motor controller activities. Motor 120 may require a power line 125. The power for the motor may come from any of a number of sources, either associated with the jack assembly (such as a battery pack on the frame, not shown) or from a separate supply (not shown). Additionally, motor 120 may also have a control line 130, especially if the motor is a stepping motor. Such a control line may comprise a plurality of physical wires, each carrying a specific control signal. It can be appreciated that the power line 125 and control line 130 do not have to comprise separate physical lines, but may be bundled together into a cable assembly that attaches to motor 120 through a single electrical interface (not shown).

The displacement of support surface 50 above the jack assembly frame may be important to the operator of the jack assembly. Encoder devices may provide information related to the support plate displacement. In an embodiment, the displacement of the support surface 50 from the frame may be determined based on the physical travel of drive members 30 and 31. In one embodiment, the travel of a drive member may be determined based on a linear encoder, wherein the non-moving component of the encoder may be fixed to one of the opposing side members 12 or 13, and encoder moving member may be fixed to one of the two drive members 30 or 31. Non-limiting examples of such an encoder include resistive, inductive, optical and magnetic encoders. The encoders may also be either incremental or absolute. In one embodiment, the power for such an encoder may be sourced from a battery pack associated with the jack assembly frame. In an alternative embodiment, the power may be provided by a source not physically associated with the jack assembly. The encoder output may be directed to conditioning electronics to provide an encoder data signal. Such conditioning electronics may include, as non-limiting examples, amplifiers, filters, analog-to-digital converters, microprocessors, dynamic and static memory devices, and other electronics known in the field of electronic signal processing. In one embodiment, the conditioning electronics may be associated with the jack assembly. In a further embodiment, the encoder data signal may be in data communication with an encoder display mounted on the frame assembly to notify an operator of the displacement of support surface 50 above the frame. In an alternative embodiment, the encoder data signal may be provided to a separate device not associated with the jack assembly.

As an alternative to the linear encoder, a rotary encoder may be used to determine the displacement of the support plate by measuring the amount of rotation of screw 20. In one embodiment, the rotary encoder comprises an incremental encoder attached to screw drive 60. In another embodiment, the rotary encoder is attached to motor shaft 115. In still another embodiment, the rotary encoder may be incorporated within the housing of motor 120. The power for the rotary encoder may be supplied by a power source associated with the jack assembly frame, or may be supplied from another source such as the source for the power and control signals for a stepper motor. Similar to the output of a linear encoder, the output of the rotary encoder may also be directed to conditioning electronics to provide an encoder data signal, and the encoder data signal may be used as a data input to an encoder display.

It is understood that an output of an encoder device may be supplied to a motor controller to provide feedback for the control of motor 120. However, it should be further understood that embodiments incorporating positional encoders do not necessarily require motor 120 to operate screw drive 60.

In addition to positional encoders, other sensors are contemplated for use with the jack assembly. Limit switches may be incorporated into the jack assembly. In one embodiment, the body of a limit switch may be associated with one of the side members 12 or 13 of the frame, and positioned so that the limit switch activator is depressed when a drive member 30 or 31 is approximate to the activator. In one embodiment, the limit switch output may be used to activate a limit switch display to notify the operator that the travel of the drive members is close to a physical limit. In another embodiment, the limit switch output may be supplied to a motor controller to prevent motor 120 from operating screw 30 past a desired endpoint.

In addition to the sensors disclosed above, a weight or force sensor may be associated with support surface 50, to measure to load placed on the plate. Such a sensor may find utility in determining if the load on the jack assembly exceeds the capabilities of jack or motor components. Examples of such force sensors may include piezo-sensor films or piezo-electric stacks. The force sensor may be associated with drive and conditioning electronics to provide a force signal. In one embodiment, the force signal may be used to prevent motor 120 from operating if the load exceeds a threshold value, or if the load on support surface 50 is incapable of motion (for example due to blockage). In another embodiment, the force signal may be supplied to a load display mounted on the jack assembly to notify the operator that the load exceeds the safe operating load weight. Examples of such a display may include a simple red LED that is powered if the load is too great, or a display of the weight of the load on support surface 50.

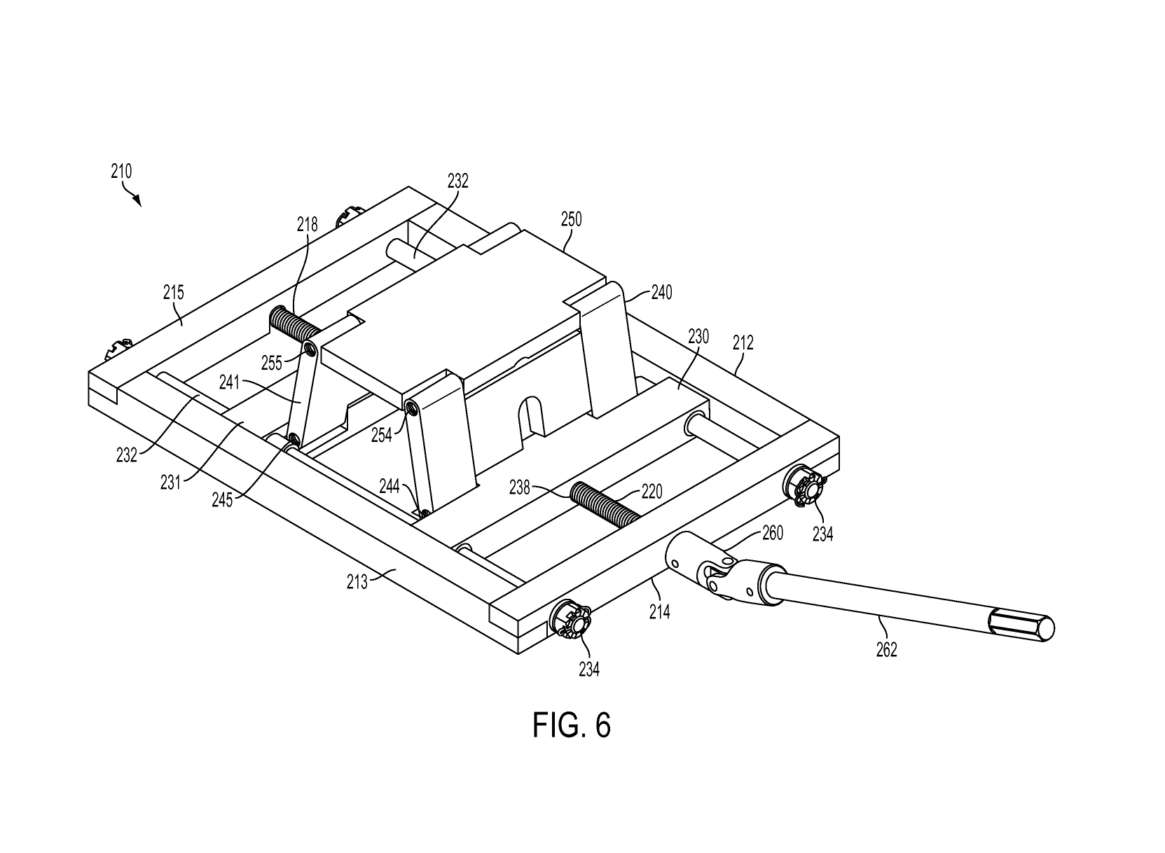

FIG. 6 illustrates a second embodiment of a screw-operated jack-assembly 210 in an extended position. The jack assembly includes a rigid frame that includes a pair of opposing side members 212, 213 and a pair of opposing end members 214, 215 that together provide a rectangular support structure. Other shapes and configurations of the frame are possible. A dual-threaded screw 220 extends from the first end member 214 to the second end member 215. The screw 220 includes a first section having a right-handed thread and a second section having a left-handed thread. Each end of the screw is directly or indirectly attached to an end member via a non-threaded receptacle 218 that prevents lateral movement of the screw while allowing the screw to rotate.

A screw drive 260, which is a handle, hook, cap, or other structure that may be grasped to rotate the screw, is attached to one end of the screw so that the screw may be rotated by an external force. As shown in FIG. 6, the screw 220 extends through end member 214 and into screw drive 260, but other positions and configurations of the screw and screw drive are possible. The screw drive may be attached to a handle 262 that allows a person to turn the screw. Alternatively, the screw drive 260 may include an integral handle or other structure that assists in turning of the screw. Optionally, the screw drive 260 and/or handle 262 may be attached to an external motor or other power-driven mechanism that turns the screw when activated.

Two movable drive members 230, 231 are each attached to the screw 220 by an internal threaded receptacle 238. The internal thread of one of the drive members 230 mates with the screw's left-handed thread and the internal thread of the other drive member 231 mates with the screw's right-handed thread, or vice-versa. When the screw 220 is rotated in one direction (e.g., clockwise), the drive members will move along the screw toward each other. When the screw 220 is rotated in the opposite direction (e.g., counterclockwise), the drive members will move away from each other.

An extendable platform that includes a pair of side walls 240, 241 and a support surface 250 is positioned between the drive members 230, 231. Each side wall 240, 241 is directly or indirectly connected to one of the drive members by a hinge 244, 245, which is a connecting mechanism that allows the side wall to turn upward when the drive members move together and turn downward when the drive members move apart. Each hinge may include a pin and receptacle, axle, linear bearing or other structure that allows for extension of the hinge's side wall up and away from the frame. The support surface 250 is positioned between the side walls and is similarly attached to each side wall 240, 241 by a hinge 254, 255 so that the plate remains in a planar position (i.e., parallel to the frame) as it is raised when the side walls are extended.

Optionally, the jack assembly may include one or more lateral support members 232 positioned within the frame and extending in a direction that is parallel to the screw. Each support member 232 is a structure that provides support for the drive members 230, 231. As shown in FIG. 6, the support members 232 are rods that are positioned along opposing sides of the screw, and the support members extend through (and thus support) each drive member. Optionally, the support members 232 may extend through the end members 234, 235 of the frame and be secured in place at one or both ends by a cap 234, such as a nut, collar with pin, or other securing structure. The support members need not be rods as shown, but could be other structures, such as a ledge or channel formed within the frame's side members, wheels or bearings positioned on the underside of the drive members, or other supporting structures.

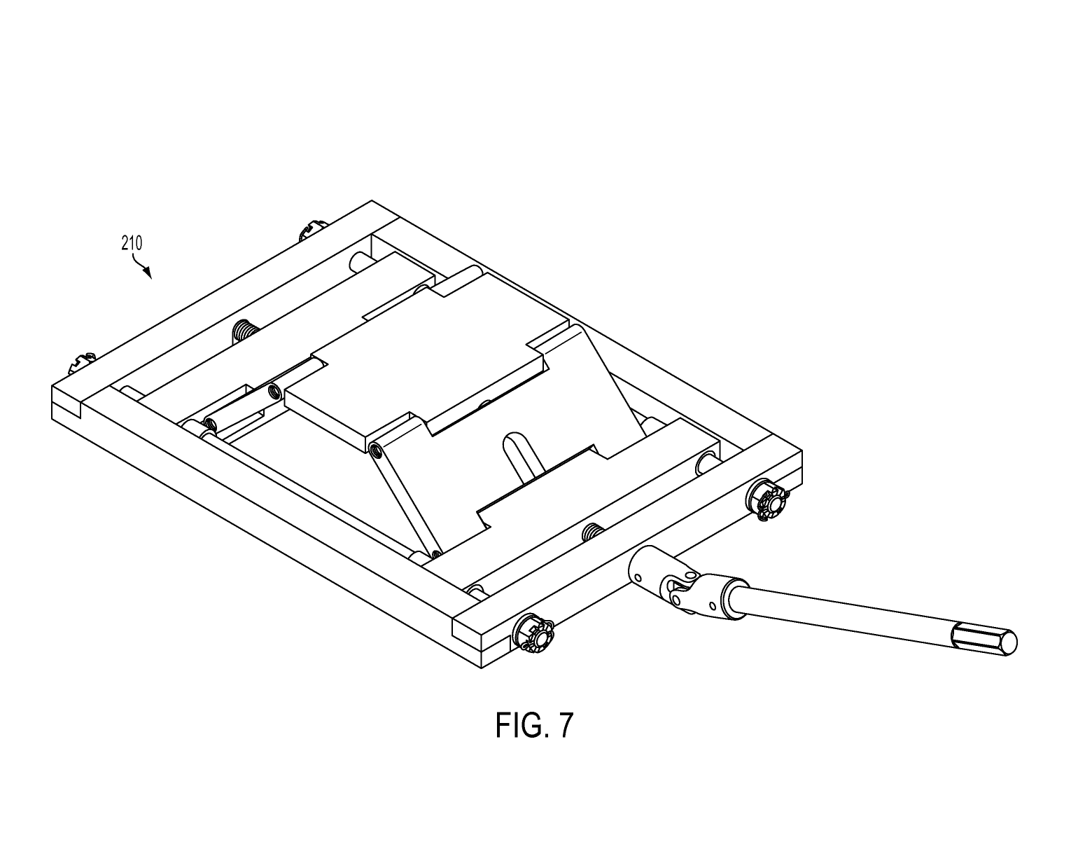

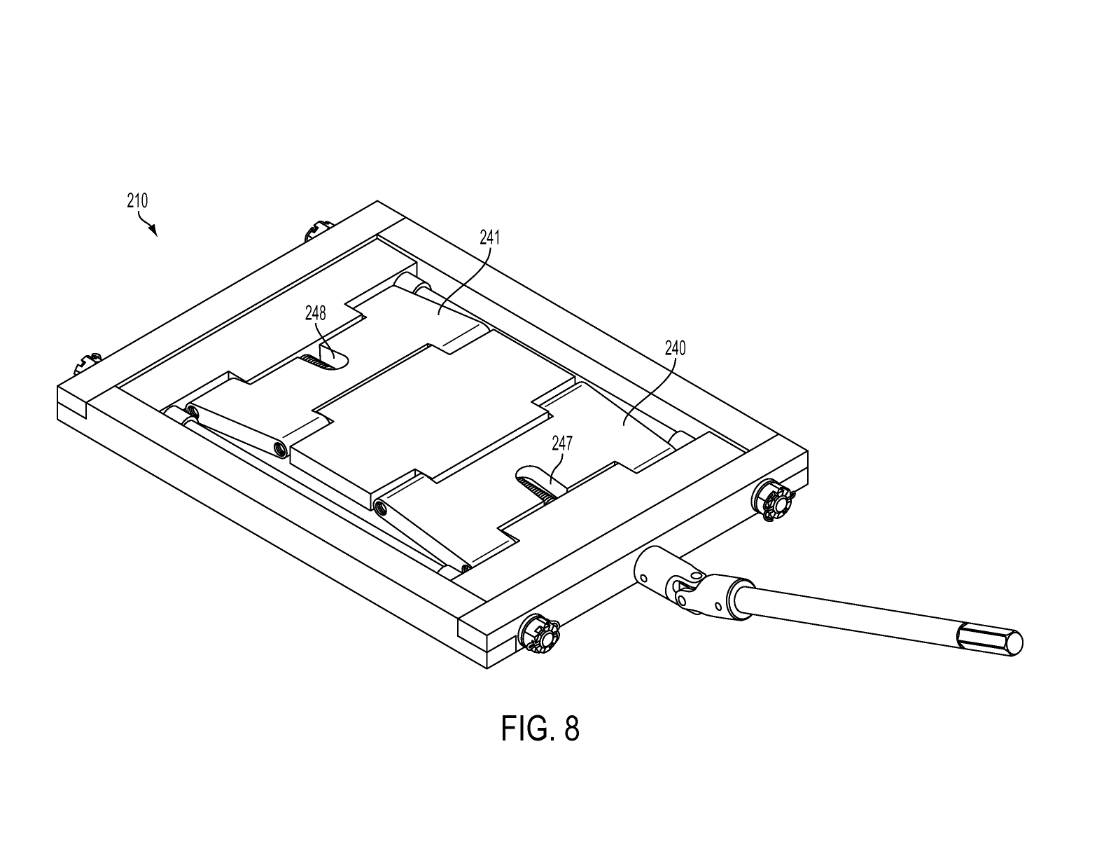

FIG. 6 shows the second embodiment of a jack assembly 210 in a fully extended position. FIG. 7 shows the second embodiment of the jack assembly 210 in a partially extended position, and FIG. 8 shows the second embodiment of the jack assembly 210 in a retracted position. FIG. 8 also illustrates that each of the side walls 240, 241 of the extendable platform may include a relief area 247, 248 to accept a portion of the screw when the platform is retracted. Each relief area 247, 248 may be in the form of an opening as shown, or it may be in the form of a channel or groove on the underside of the side wall.

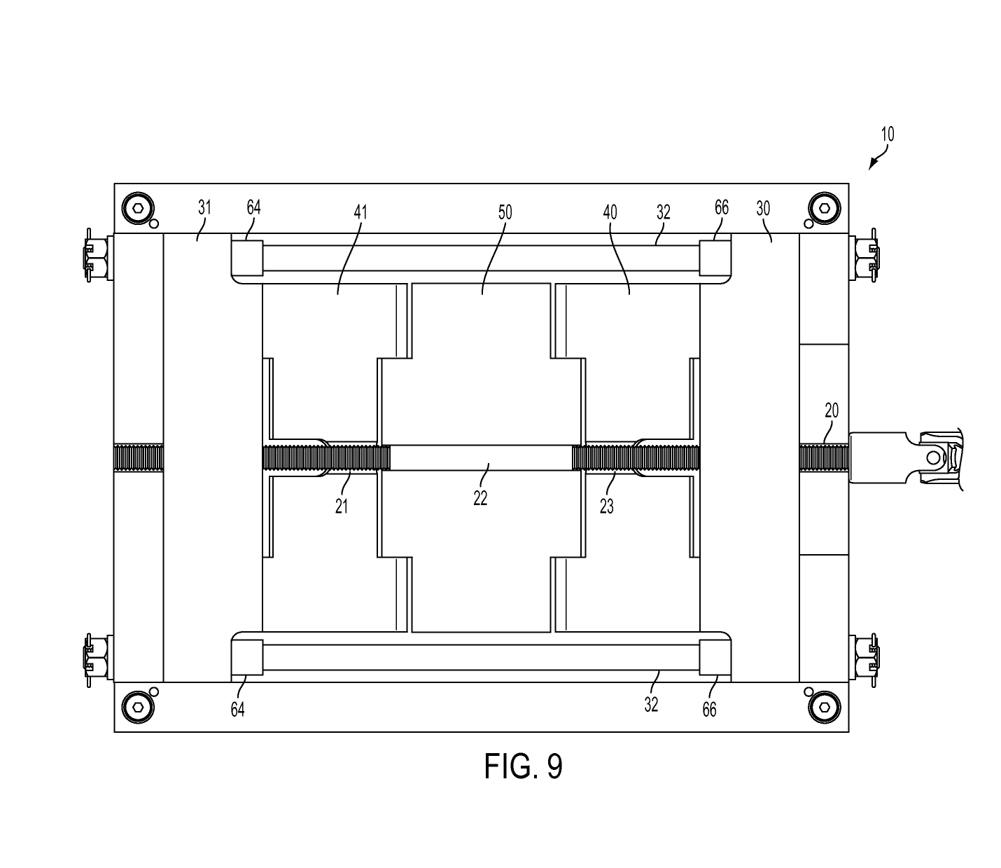

When the extendable platform is fully extended as shown in FIG. 6, in some embodiments it may be designed so that the side walls 240, 241 are angled, and thus not perpendicular to the support surface 250. This helps to distribute the load and provide pyramidal support for the load on the support plate. Several designs are possible to ensure that the side walls are not allowed to become vertical. For example, referring to FIG. 9 and its view of a jack assembly from its underside, the screw 220 may have a non-threaded section 222 positioned between the right-hand thread 221 and the left-hand thread 223. The non-threaded section 222 may have a length that is larger than the width of the support surface 250 so that it limits lateral movement of the drive members toward each other and the side walls 240, 241 are never driven to be positioned completely underneath the support surface 250. Alternatively, a sleeve or other barrier may be placed over a central portion of the screw to serve as the non-threaded section 222. In addition or alternatively, each support member 232 may include a pair of bushings 262, 264 that limit movement. For example, the bushings may contact each other when the platform is extended, thus limiting further movement of the drive members. Alternatively, the support members 232 may have a stop (such as a fixed washer, a rim, or a central portion with an outer diameter that is larger than the inner diameter of the bushings) that prevents further movement of the drive member when the bushing meets the stop.

Similarly, when the extendable platform is retracted as shown in FIG. 8, in some embodiments it may be designed so that the side walls 220, 241 are angled, and not parallel, with respect to the support surface 250. This helps to avoid placing a load on the screw when the device is retracted. Several designs are possible to ensure that this happens, such as designing the components of the extendible platform to be larger than a size that would allow the side walls to lie flat when the drive members reach their outer limit. When in a retracted position, in some embodiments the support surface 250 does not extend above the height of the frame so that the assembly may be easily stored.

Referring again to FIG. 9, the screw 240 is shown as a solid member having three sections: a non-threaded section 222 positioned between the right-hand thread 221 and the left-hand thread 223. The non-threaded section 222 is optional, and the right-hand thread 221 may abut the left-hand thread 223. In addition, the screw 220 may be made of multiple components that are interconnected by welding, mating, threading, or other connection devices. Each threaded area may have a trapezoidal thread form such as an Acme thread form, a square thread form, or a different type of thread form.

Optionally, the assembly may include a locking mechanism to secure the platform when it is in a raised position. Alternatively, the force of a load on the support surface 250 alone may be sufficient to disperse a force through the side walls 240, 241 to the drive members 230, 232 so that the internal threads of the drive members are forced against the screw threads to secure the platform in place by friction.

In some embodiments the support surface 250 may include one or more structures that are configured to secure a load in place. For example, the support plate may include one or more integral or attached channels, receptacles, clamps, grooves, indentations, extensions, or other structures that are configured to position and/or receive the load.

In either embodiment, the jack assembly components may be made of various rigid materials. For example, some or all of the frame, screw, drive members, support members, side walls, and support plate may be made of steel, aluminum, another metal or alloy, rigid plastic, or another material. The frame may have a low profile to allow it to be used in small areas. For example, the height of the frame (and the entire assembly when in a retracted position) may be less than 2 inches, less than 1½ inches, or any size between ½ inch and 3 inches. The dimensions of the frame may be similar to a book or tablet (e.g., 8″×10″, 8½″×11″, 8½″×14″) or another structure depending on storage and use. Other frame heights and dimensions are possible.

The jack assemblies may be used for multiple applications. For example, the jack assemblies may be used to raise and support a recreational vehicle trailer, another vehicle, a motor home, a plunger assembly of a glass manufacturing machine, a dumpster receptacle, or another structure.

Some or all of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the claims.

1. A jack assembly, comprising:
a dual threaded screw comprising a right-handed section having a right-hand thread and a left-handed section having a left-hand thread;
a first drive member having an internal thread that mates with the right-hand thread of the screw;
a second drive member having an internal thread that mates with the right-hand thread of the screw; and
an extendible platform that is pivotably related to the first drive member and the second drive member and configured so that when the screw is rotated in a first direction, the drive members move toward each other and the platform moves to an extended position, and when the screw is rotated in a second direction the drive members move away from each other and the platform moves to a retracted position.

2. The assembly of claim 1, wherein the extendible platform further comprises:
a first side wall and a first hinge that connects the first side wall to the first drive member; and
a second side wall and a second hinge that connects the second side wall to the second drive member.

3. The assembly of claim 2, wherein the extendible platform further comprises:
a support surface positioned between the first side wall and the second side wall;
a third hinge that connects the support surface to the first side wall; and
a fourth hinge that connects the support surface to the second side wall.

4. The assembly of claim 2, wherein the extendible platform further comprises a receiving structure that is positioned between the first side wall and the second side wall when the platform is in the extended position.

5. The assembly of claim 2, wherein the screw comprises a non-threaded section positioned between the right-hand thread and the left-hand thread, wherein the non-threaded section has a length that exceeds a corresponding width of the support surface.

6. The assembly of claim 2, further comprising at least one lateral support member that is positioned to be parallel to the screw and to support the drive members.

7. The assembly of claim 1, wherein at least one of the right-hand thread and the left-hand thread comprises an Acme thread form.

8. The assembly of claim 6, further comprising a frame to which the screw and the at least one lateral support member are attached.

9. The assembly of claim 3, wherein when the extendible platform is in the retracted position the support surface does not extend above a height of the frame.

10. The assembly of claim 3, wherein when the extendible platform is in the extended position, the support surface is elevated above the frame.

11. The assembly of claim 2, wherein the side walls are not perpendicular to the support surface when the extendible platform is in a fully extended position.

12. The assembly of claim 1, further comprising a handle in operative connection with the screw.

13. The assembly of claim 1, further comprising a motor in operative connection with the screw.

14. The assembly of claim 1, further comprising a plurality of legs that extend angularly downward and away from the frame.

15. A jack assembly, comprising:
a dual threaded screw comprising a right-handed section having a right-hand thread and a left-handed section having a left-hand thread;
a first drive member having an internal thread that mates with the right-hand thread of the screw;
a second drive member having an internal thread that mates with the right-hand thread of the screw;
a frame configured to support the screw, the first drive member and the second drive member; and
an extendible platform comprising:
a first side wall that is pivotably connected to the first drive member, and
a second side wall that is pivotably connected to the second drive member,
wherein the extendible platform that is attached to the first drive member and the second drive member and configured so that when the screw is rotated in a first direction, the drive members move toward each other and the platform is in an extended position, and when the screw is rotated in a second direction, the drive members move away from each other and the platform is in a retracted position.

16. The assembly of claim 15, wherein the extendible platform further comprises:
a support surface positioned between the first side wall and the second side wall;
a third hinge that connects the support surface to the first side wall; and
a fourth hinge that connects the support surface to the second side wall.

17. The assembly of claim 15, wherein the extendible platform further comprises a receiving structure that is positioned between the first side wall and the second side wall when the platform is in the extended position.

18. The assembly of claim 15, wherein the screw comprises a non-threaded section positioned between the right-hand thread and the left-hand thread, wherein the non-threaded section has a length that exceeds a corresponding width of the support surface.

19. The assembly of claim 15, further comprising at least one lateral support member that is positioned to be parallel to the screw and to support the drive members.

20. The assembly of claim 15, wherein at least one of the right-hand thread and the left-hand thread comprises an Acme thread form.

21. A jack assembly, comprising:
a dual threaded screw having an Acme thread form and comprising a right-handed section having a right-hand thread and a left-handed section having a left-hand thread;
a first drive member having an internal thread that mates with the right-hand thread of the screw;
a second drive member having an internal thread that mates with the right-hand thread of the screw;
a frame configured to support the screw, the first drive member and the second drive member; and
an extendible platform comprising:
a first side wall that is pivotably connected to the first drive member,
a second side wall that is pivotably connected to the second drive member,
a support surface positioned between the first side wall and the second side wall,
a third hinge that connects the support surface to the first side wall, and
a fourth hinge that connects the support surface to the second side wall;
wherein the extendible platform that is attached to the first drive member and the second drive member and configured so that when the screw is rotated in a first direction, the drive members move toward each other and the platform is in an extended position, and when the screw is rotated in a second direction, the drive members move away from each other and the platform is in a retracted position.
